(19) United States
(12) Patent Application Publication
(10) Pub. No.: US 2012/0219273 A1
(43) Pub. Date: Aug. 30, 2012

(54) Digital video recording apparatus, system and method with catchup viewing feature

(76) Inventor: Thomas J. McWilliams, Bryn Mawr, PA (US)

(21) Appl. No.: 12/932,503

(22) Filed: Feb. 25, 2011

(51) Int. Cl. H04N 5/783

(52) U.S. Cl. 386/344; 386/E05.052

(57) ABSTRACT

An apparatus, system and method for providing digital video recorder having an expedited viewing mode. The apparatus, system and method include at least one microprocessor, at least one storage element for storing at least one audiovisual program played at a first rate pursuant to an instruction from the at least one microprocessor, and computing code resident on the at least one microprocessor which, when the expedited viewing mode is executed by the microprocessor, plays from storage at least a portion of audio and video of the at least one audiovisual program at at least one of 1.25 times the first rate, 1.5 times the first rate, and 1.75 times the first rate.

### CROSS-REFERENCE TO RELATED APPLICATIONS

This application claims the benefit of priority to U.S. Provisional Patent Application Ser. No. 60/339,126, filed on Feb. 26, 2010 by inventor Thomas J. McWilliams, entitled “DIGITAL VIDEO RECORDING APPARATUS, SYSTEM AND METHOD WITH CATCHUP VIEWING FEATURE,” the entirety of which is incorporated herein by reference as if set forth in its entirety.

### BACKGROUND

1. Field of the Invention

The present invention relates to a digital video recorder, and, more particularly, to a digital video recording apparatus, system and method with catchup viewing feature.

2. Background of the Invention

A digital video recording device (DVR) is a device that records, onto a digital media, multiple audiovisual programs. As used herein, a DVR includes a local and remote (rDVR) recorder, a personal video recorder, high definition DVRs (HDDVRs) and standard definition DVRS (SDDVRs). Also, as used herein, a DVR includes not only any hardware, but additionally any software, and the DVR service itself, necessary to provide the digital recording capability discussed hereinthroughout.

DVRs are typically offered as separate branded services to, or as add-on services with, for example, existing cable, digital cable, satellite, fiber optic/telephonic, or antenna based programming services. DVR service is typically subscription-based and interactive, and lets a viewer program and control which television shows are watched, and when. As such, programming information, such as a channel map, channel lineup, or the like, is available to the DVR, in order to allow for selection of desired programming, as well as the programming itself corresponded to the channel map or lineup.

DVRs may be included in other hardware, such as in an Internet Protocol (IP) television or a set-top box (STB), or may require the purchase of a physically independent digital video receiver/recorder. The hardware is typically compatible with received cable, digital cable, direct broadcast satellite, or rooftop antenna programming. The DVR generally connects to and/or interfaces with a display, such as a television, and a STB, satellite receiver, antenna, or the like. A secondary archive device may be connected to the DVR, such as a video cassette recorder (VCR) or a DVD recorder/burner, for example.

A DVR includes all required data and software to allow for interactive programming features, including the ability to record desired programming, as well as to manipulate programming by, for example, pausing, rewinding, fast forwarding, or instantly replaying all or a portion of a program, such without missing succeeding aspects of the program. Typically, for example, a user may fast forward through aspects of a program the user does not desire to view. This fast forwarding is generally available at 2×, 3×, 4×, or the like multiple of typical viewing speed, and is generally provided without sound. Sound is not provided in order to minimize processing, and to avoid nuisance to the user, since sound would not be acceptably processed by the user at such speeds.

The capability of the DVR to skip only those aspects of a program that are not of interest to the user, in conjunction with the capability of a DVR to record voluminous amounts of programming, lead many a DVR user to suffer from more recorded programming than the user can enjoyably watch. This may lead a user to not record programs of interest to the user, in part because the DVR of the user lacks the capacity to record additional programming without removing existing recordings.

Thus, a need exists for a DVR apparatus, system and method that allows a user to enjoyably watch voluminous amounts of stored programs at a rate that allows for expedited removal of the programs to enable recording of additional programs.

### SUMMARY OF THE INVENTION

An apparatus, system and method for providing a digital video recorder having an expedited viewing mode. The apparatus, system and method include at least one microprocessor, at least one storage element for storing at least one audiovisual program played and/or received at a first rate pursuant to an instruction from the at least one microprocessor, and computing code resident on the at least one microprocessor which, when the expedited viewing mode is executed by the microprocessor, plays from storage at least a portion of audio and video of the at least one audiovisual program at at least one of 1.25 times the first rate, 1.5 times the first rate, and 1.75 times the first rate.

More particularly, the apparatus, system and method may include receiving a program at a first play rate at a first input to a digital video recorder, storing the program on at least one memory associated with the digital video recorder, and, responsive to receipt of an instruction from a user having an account associated with the digital video recorder, playing back interlaced audio and video of the recorded program at one of 1.25 times the first rate, 1.50 times the first rate, and 1.75 times the first rate.

Thus, the present invention provides a DVR apparatus, system and method that allows a user to enjoyably watch voluminous amounts of stored programs at a rate that allows for expedited removal of the programs to enable recording of additional programs.

### BRIEF DESCRIPTION OF THE FIGURES

Understanding of the disclosure will be facilitated by consideration of the following detailed description of the embodiments of the disclosure, taken in conjunction with the accompanying drawings, in which like numerals refer to like parts, and wherein:

FIG. 1 is a block diagram illustrating aspects of a digital video recorder having an expedited playback mode; and

FIG. 2 is a flow diagram illustrating aspects of an exemplary method in accordance with the present invention.

### DETAILED DESCRIPTION OF THE INVENTION

It is to be understood that the figures and descriptions of the disclosure have been simplified to illustrate elements that are relevant for a clear understanding, while eliminating, for the purpose of brevity, many other elements found in typical digital video recording apparatuses, systems and methods. Those of ordinary skill in the art will thus recognize that other elements and/or steps are desirable and/or required in implementing the disclosure. However, because such elements and steps are well known in the art, a discussion of such elements and steps is not provided herein. The disclosure herein is directed to all such variations and modifications to such elements and methods known to those skilled in the art.

Digital Video Recorders (DVR) are well-known in the available art. Such DVRs may typically record any or nearly any showing of an audio-visual program that passes through the DVR, such as for display on a connected television set or computing monitor. Such audio-visual programs can typically be recorded, if available, in high definition format or standard definition format, and may, such as at playback, enable a user to fast forward or rewind parts of the program. DVRs may include, receive, or otherwise have associated therewith, information that increases user convenience for use of the DVR, such as interactivity with channel lineups and on-demand programming, for example. DVRs include a variety of types, such as stand-alone residential DVRs, remote DVRs at remote locations, such as at edge servers in cable systems, for example, DVR capabilities in Internet Protocol (IP) televisions, HD DVRs, SD DVRs, and the like.

However, currently available DVRs, although a significant increase in efficiency over previous technologies, such as video cassette recorders (VCRs), allow a user to increase the efficiency of watching a television program only marginally. That is, most users fast forward only through those parts of the audio-visual program that are not of interest to the user, thereby leaving the bulk of the audio-visual program to be viewed in actual time. This creates a particular issue for users who record large numbers of programs on their respective DVRs, at least in that such users can typically save, at most, approximately 15 minutes of time (in eliminating much of the programming time taken up by advertisements) when viewing a one-hour television program.

Thus, the present invention provides a “catchup” feature, in which, unlike the prior art, fast forward audio is provided, rather than simply fast forward video, wherein multiple speeds are available to move through an audio-visual program, which multiple available video speeds may be slower than those typically available through the fast forward feature in current DVRs and similar technology in order to allow the user to process and enjoy viewing the program in spite of the increased speed of play. Those skilled in the art will appreciate, in light of the disclosure herein, that the present invention is applicable for all types of DVRs, including, but not limited to, residential DVRs, remote DVRs, SD DVRs, HD DVRs, and IP television DVR.

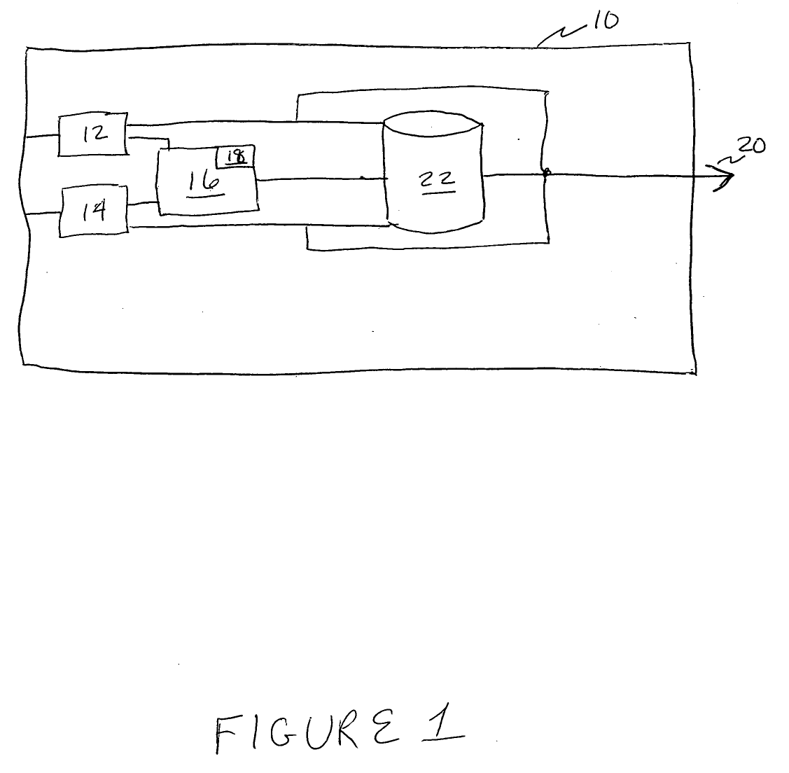

FIG. 1 illustrates a DVR in accordance with the present invention. The DVR 10 may include a programming receiver 12, a programming lineup receiver 14, and at least one microprocessor 16. The microprocessor may include computing code 18, wherein the computing code 18 is capable of providing interactivity with ones of the programs received at receiver 12 and with ones of the lineup at receiver 14, such that programming can be recorded from receiver 12, at a time and place indicated by receiver 14, to one or more storage elements 22, as dictated by microprocessor 16 and for output to a viewer, such as via output 20. Further, the interactivity indicated by computing code 18 may further include manipulation of programming stored at storage element 22, such as a recordings menu, a list of items to be recorded, a list of recommended items for recordation, and inter-program interactivity, such as play, pause, stop, rewind, and fast forward, for example.

For example, the software associated with a microprocessor of the DVR may, in accordance with the present invention, allow for play back of an audio visual program in, for example, 1.25× of real time, 1.5× of real time, and 1.75× of real time, wherein, in each such playback mode, sound is provided at the same multiple of speed as that selected for video—that is, the original program play of the audio and the video remains interlaced at the increased playback speeds. Thereby, in contradistinction to the aforementioned prior art example wherein the available art saves a viewer, at maximum, 15 minutes of viewing time typically allotted to advertising, the present invention allows the 45 remaining minutes of television programming of interest to the user in the one hour program to be watched by the viewer faster, without the viewer missing any content of interest within the television program. Thereby, the present invention allows for the user to watch programs faster, particularly when numerous programs have been recorded on the user's DVR.

This “catchup” feature of the present invention may be made available to the user for all programs, may be made available with a typical fast forward feature (2×, 3×, 4×, 5×, etc.) also made available in the same playback and/or in an alternative real-time playback mode, or may be made available as an option prior to playback of a program. For example, a user may be provided with a choice upon selecting a playback of an audio-visual program, wherein the choice asks the user to select whether the user would like to watch the program in normal mode, such as with the 2×, 3× and 4× fast forward options, or in catchup mode, with at least the 1.25X, 1.5X, and 1.75X fast forward options, or in normal catchup mode, with the 1.25×, 1.5× and 1.75× playback with sound fastforward options and the 2×, 3× and 4× or more fast forward soundless playback options also available.

For example, if the user selects normal catchup mode, the user may also have available the normal fast forward feature, such as a 2×, 3×, 4× or 5×, such as to move through commercials, in conjunction with the aforementioned catchup viewing speeds. Alternatively, the user may not have available the normal higher rate fast forwards of a normal playback in catchup mode. Thereby, although the user can move through a program faster in catchup mode, the user may optionally be forced to watch and listen to commercials, albeit at the increased catchup viewing pace over the rate designed by the advertisers. As such, the present invention may increase the relevance of advertising for television advertisers to levels available prior to mass implementation of DVR technology.

Further, the present invention may make catchup mode available to a user at all times, or may make catchup mode available only when a certain amount of programming is stored on the user's DVR. For example, once a user's DVR becomes more than 50% full with respect to the storage allotted in association with the microprocessor of the DVR, catchup mode may become available to the user, whereby the user may catchup with the user's viewing by playing back the user's programming at the aforementioned increased pace.

As discussed above, in order to optimize user viewing efficiency, the user would best be enabled to watch multiple programs quickly by having higher levels of fast forward also available during catchup mode, but revenue may be maximized by locking the user using catchup mode into using only the lower fast forward speeds. More specifically, advertising revenue may increase if advertisers are assured that a respective advertisement will be viewed and heard by a user, although possibly at an increased pace. On the other hand, a user may pay an increased subscription rate to have both catchup and high-rate fast forward available in a single mode.

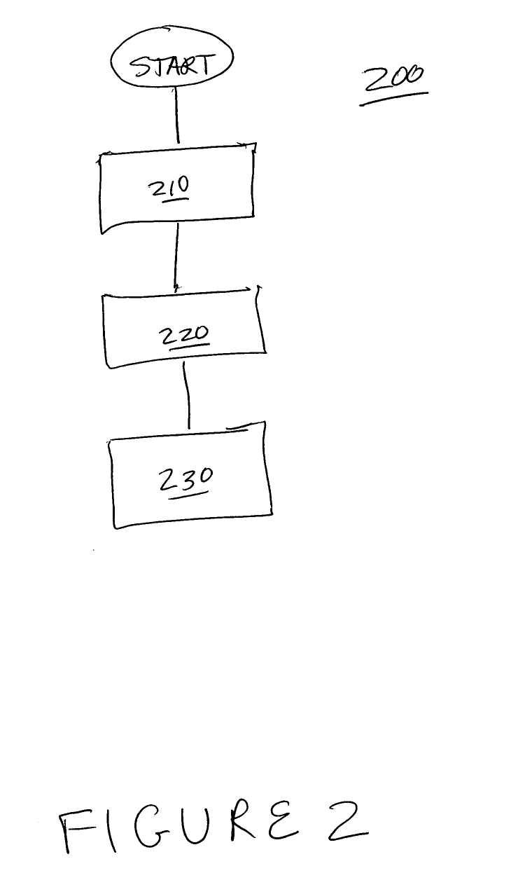

FIG. 2 is a flow diagram illustrating an exemplary method 200 in accordance with the present invention. The method 200 includes receiving a plurality of audiovisual programs at step 210, storing at least one of the audiovisual programs at a first play rate at step 220, and playing back at step 230, pursuant to a user request, the stored at least one of the audiovisual programs at a second play rate that is in a range of 1.25× to 1.75× the first play rate. More particularly, the second play rate must be a playback rate at which the audio and video is readily processed by a viewer.

Although the disclosure has been described and pictured in an exemplary form with a certain degree of particularity, it is understood that the present disclosure of the exemplary form has been made by way of example, and that numerous changes in the details of construction and combination and arrangement of parts and steps may be made without departing from the spirit and scope of the disclosure as set forth in the claims hereinafter.

What is claimed is:

1. A digital video recorder having an expedited viewing mode, comprising:
at least one microprocessor;
at least one storage element for storing at least one audiovisual program played at a first rate pursuant to an instruction from said at least one microprocessor; and
computing code resident on said at least one microprocessor which, when the expedited viewing mode is executed by said microprocessor, plays from storage at least a portion of audio and video of the at least one audiovisual program at at least one of 1.25 times the first rate, 1.5 times the first rate, and 1.75 times the first rate.

2. The digital video recorder of claim 1, wherein the instruction includes at least a lineup of times and channels of ones of the at least audiovisual program.

3. The digital video recorder of claim 2, wherein the instruction from said at least one microprocessor is issued responsively to a user indication.

4. The digital video recorder of claim 3, further comprising at least one user interface menu provided by said microprocessor, wherein the user indication is entered on the user interface menu.

5. The digital video recorder of claim 1, wherein said computing code further comprises a fast forward non-viewing mode that plays from storage only the video of the at least one audiovisual program at one of 2×, 3× and 4× of the first rate.

6. A method of providing expedited, viewable playback of an audiovisual program from a digital video recorder, comprising:
receiving a plurality of audiovisual programs at the digital video recorder;
providing for selection of the audiovisual program from the plurality of audiovisual programs;
storing the audiovisual program at a first play rate on the digital video recorder; and
playing back, pursuant to a user request, audio and video of the stored audiovisual program at a second play rate that is viewable and that is in a range of 1.25× to 1.75× the first play rate.
